(19) United States
(12) Patent Application Publication
(10) Pub. No.: US 2026/0212119 A1
(43) Pub. Date: Jul. 23, 2026

(54) AUTOREGRESSIVE GENERATION UTILIZING FULL PROBABILITY DISTRIBUTION

(71) Applicant: International Business Machines Corporation, Armonk, NY (US)

(72) Inventors: Ulrich Alfons Finkler, YORKTOWN HEIGHTS, NY (US); Xiaojie Guo, YORKTOWN HEIGHTS, NY (US)

(21) Appl. No.: 19/028,889

(22) Filed: Jan. 17, 2025

(51) Int. Cl. G06F 40/284

(52) U.S. Cl. CPC G06F 40/284

(57) ABSTRACT

An example operation includes one or more of executing an autoregressive generation process of a generative machine learning model by producing a prediction of a first answer token that is represented by a first probability distribution over V values, where V represents a number greater than one of tokens in a predefined governing set of tokens, wherein the first probability distribution is fed back as input to the generative machine learning model for a next iteration of the autoregressive generation process, the next iteration produces a next answer token represented by a next probability distribution, and the executing produces an output from the generative machine learning model, the output being based on probability distributions including the first probability distribution and the next probability distribution.

### BACKGROUND

Autoregressive generation is an iterative process for generating data sequences, for example, text sequences, image sequences, audio sequences, etc., where each new data element in the sequence is predicted based on the previous data elements that the process has already predicted. Autoregressive generation is often performed by machine learning models, such as large language models (LLMs).

### SUMMARY

One example embodiment provides a method that may include one or more of executing an autoregressive generation process of a generative machine learning model by producing a prediction of a first answer token that is represented by a first probability distribution over V values, where V represents a number greater than one of tokens in a predefined governing set of tokens, wherein the first probability distribution is fed back as input to the generative machine learning model for a next iteration of the autoregressive generation process, the next iteration produces a next answer token represented by a next probability distribution, and the executing produces an output from the generative machine learning model, the output being based on probability distributions including the first probability distribution and the next probability distribution.

Another example embodiment provides a computer system that may include a processor set, one or more computer-readable storage media, and program instructions stored on the one or more computer-readable storage media to cause the processor set to perform operations comprising that may include one or more of executing an autoregressive generation process of a generative machine learning model by producing a prediction of a first answer token that is represented by a first probability distribution over V values, where V represents a number greater than one of tokens in a predefined governing set of tokens, wherein the first probability distribution is fed back as input to the generative machine learning model for a next iteration of the autoregressive generation process, the next iteration produces a next answer token represented by a next probability distribution, and the executing produces an output from the generative machine learning model, the output being based on probability distributions including the first probability distribution and the next probability distribution.

A further example embodiment provides a computer program product that may include a set of one or more computer-readable storage media, and program instructions stored on the one or more computer-readable storage media to perform operations that may include one of more of executing an autoregressive generation process of a generative machine learning model by producing a prediction of a first answer token that is represented by a first probability distribution over V values, where V represents a number greater than one of tokens in a predefined governing set of tokens, wherein the first probability distribution is fed back as input to the generative machine learning model for a next iteration of the autoregressive generation process, the next iteration produces a next answer token represented by a next probability distribution, and the executing produces an output from the generative machine learning model, the output being based on probability distributions including the first probability distribution and the next probability distribution.

### BRIEF DESCRIPTION OF THE DRAWINGS

FIG. 1 is a diagram illustrating a computing environment according to an embodiment of the instant solution.

FIG. 2 is a diagram illustrating a process of a machine learning model performing an autoregressive generation process according to examples and features of the instant solution.

FIG. 3A is a diagram illustrating a process of generating a probability distribution according to examples and features of the instant solution.

FIG. 3B is a diagram illustrating a process of an iteration of an autoregressive generation process according to examples and features of the instant solution.

FIG. 3C is a diagram illustrating a process of a next iteration of the autoregressive generation process according to examples and features of the instant solution.

FIG. 3D is a diagram illustrating a process of selecting tokens for output by the machine learning model according to the examples and features of the instant solution.

FIG. 4A is a flow diagram illustrating a method according to examples and features of the instant solution.

FIG. 4B is a flow diagram illustrating a method according to additional examples and features of the instant solution.

FIG. 4C is a flow diagram illustrating a method according to further additional examples and features of the instant solution.

FIG. 4D is a flow diagram illustrating a method according to yet even further additional examples and features of the instant solution.

FIG. 5A is a system diagram illustrating integration of an AI model into any decision point according to the examples and features of the instant solution.

FIG. 5B is a diagram illustrating a process for developing an AI model that supports AI-assisted computer decision points according to the examples and features of the instant solution.

FIG. 5C is a diagram illustrating a process for utilizing an AI model that supports AI-assisted computer decision points according to examples and features of the instant solution.

### DETAILED DESCRIPTION

It is to be understood that although this disclosure includes a detailed description of cloud computing, implementation of the teachings recited herein is not limited to a cloud computing environment. Rather, embodiments of the instant solution are capable of being implemented in conjunction with any other type of computing environment now known or later developed.

According to an aspect of the example embodiments, there is provided a method that includes executing an iteration of an autoregressive generation process of a machine learning model on probability distributions over V values to generate an additional probability distribution for the V values, where V represents a number of tokens in a predefined governing set of tokens, selecting a value with a greatest probability from a first probability distribution for the V values from among the probability distributions for the V values, selecting a second value with a greatest probability from a second probability distribution for the V values from among the probability distributions for the V values, translating the value and the second value to a first output token and a second output token, respectively, based on the predefined governing set of tokens, and generating an output from the machine learning model which includes a sequence of data including the first output token and the second output token. One of the technical advantages of the system is feeding back the entire probability distributions for the tokens in the governing set of tokens during each iteration of the autoregressive generation process. By keeping all of the probability distributions, the next iteration of the autoregressive generation process can explore more answers and result in a more accurate response.

In some embodiments, the method may further include receiving a set of input tokens, generating a set of probability distributions for the set of input tokens, respectively, wherein each probability distribution of the set includes a respective one-hot encoded representation of a respective input token with respect to the V tokens in the predefined governing set of tokens. The technical advantage of this approach is using one-hot encoding during a first iteration of the autoregressive generation process to adapt the input data to a format that can be processed as asset of probability distributions.

In some embodiments, the method may further include embedding the probability distributions for the V values into embeddings, respectively, based on a linear embedding layer which maps a probability distribution for V values into an embedding of E values, where E is a different value than V. The V values of the probability distribution are different in size than the E values of the embeddings. The technical advantage of this step is that it modifies a size of the input data to fit into a next step of the autoregressive generation process.

In some embodiments, the method may further include converting the embeddings into feature embeddings including an additional feature embedding corresponding to a predicted response token via a transformer stack. The technical advantage of this step is that it predicts a token (part of the response) based on multiple embeddings rather than just a single embedding that gives the system more data and results in more accuracy.

In some embodiments, the method may further include converting the additional feature embedding into an additional raw probability distribution over the V tokens of the predefined governing set of tokens based on a linear layer and executing a softmax function on the additional raw probability distribution over the V tokens to generate the additional probability distribution for the V values. The technical effect of this feature is that the softmax function ensures that the sum of the probability distributions for an iteration of the autoregressive generation process is a predefined number (e.g., one, etc.)

In some embodiments, the method may further include executing a next iteration of the autoregressive generation process on the probability distributions for the V values and the additional probability distribution for the V values to generate a further additional probability distribution for the V values. The technical advantage of this step is that it uses the entire probability distribution to generate an additional probability distribution during the autoregressive generation process, whereas related process discard the probability distributions that aren't the greatest among the group.

In some embodiments, the method may further include selecting a third value with a greatest probability from the further additional probability distribution for the V values, and translating the third value to a third output token based on the predefined governing set of tokens. The technical effect of this step is that the answers can be revealed at the end, and not step-by-step because the entire probability distribution is kept, not just the token with the greatest probability. Therefore, more data is used to generate the answer resulting in more accuracy by the process.

According to an aspect of the example embodiments, there is provided a computer system that includes a processor set, a set of one or more computer-readable storage media, and program instructions, collectively stored in the set of one or more storage media, for causing the processor set to perform operations that include executing an iteration of an autoregressive generation process of a machine learning model on probability distributions over V values to generate an additional probability distribution for the V values, where V represents a number of tokens in a predefined governing set of tokens, selecting a value with a greatest probability from a first probability distribution for the V values from among the probability distributions for the V values, selecting a second value with a greatest probability from a second probability distribution for the V values from among the probability distributions for the V values, translating the value and the second value to a first output token and a second output token, respectively, based on the predefined governing set of tokens, and generating an output from the machine learning model which includes a sequence of data including the first output token and the second output token. One of the technical advantages of the system is feeding back the entire probability distributions for the tokens in the governing set of tokens during each iteration of the autoregressive generation process. By keeping all of the probability distributions, the next iteration of the autoregressive generation process can explore more answers and result in a more accurate response.

In some embodiments, the processor set may perform operations that include receiving a set of input tokens, generating a set of probability distributions for the set of input tokens, respectively, wherein each probability distribution of the set includes a respective one-hot encoded representation of a respective input token with respect to the V tokens in the predefined governing set of tokens. The technical advantage of this approach is using one-hot encoding during a first iteration of the autoregressive generation process to adapt the input data to a format that can be processed as asset of probability distributions.

In some embodiments, the processor set may perform operations that include embedding the probability distributions for the V values into embeddings, respectively, based on a linear embedding layer which maps a probability distribution for V values into an embedding of E values, where E is a different value than V. The V values of the probability distribution are different in size than the E values of the embeddings. The technical advantage of this step is that it modifies a size of the input data to fit into a next step of the autoregressive generation process.

In some embodiments, the processor set may perform operations that include converting the embeddings into feature embeddings including an additional feature embedding corresponding to a predicted response token via a transformer stack. The technical advantage of this step is that it predicts a token (part of the response) based on multiple embeddings rather than just a single embedding that gives the system more data and results in more accuracy.

In some embodiments, the processor set may perform operations that include converting the additional feature embedding into an additional raw probability distribution over the V tokens of the predefined governing set of tokens based on a linear layer and executing a softmax function on the additional raw probability distribution over the V tokens to generate the additional probability distribution for the V values. The technical effect of this feature is that the softmax function ensures that the sum of the probability distributions for an iteration of the autoregressive generation process is a predefined number (e.g., one, etc.)

In some embodiments, the processor set may perform operations that include executing a next iteration of the autoregressive generation process on the probability distributions for the V values and the additional probability distribution for the V values to generate a further additional probability distribution for the V values. The technical advantage of this step is that it uses the entire probability distribution to generate an additional probability distribution during the autoregressive generation process, whereas related process discard the probability distributions that aren't the greatest among the group.

In some embodiments, the processor set may perform operations that include selecting a third value with a greatest probability from the further additional probability distribution for the V values, and translating the third value to a third output token based on the predefined governing set of tokens. The technical effect of this step is that the answers can be revealed at the end, and not step-by-step because the entire probability distribution is kept, not just the token with the greatest probability. Therefore, more data is used to generate the answer resulting in more accuracy by the process.

According to an aspect of the example embodiments, there is provided a computer program product that includes a set of one or more computer-readable storage media, and program instructions, collectively stored in the set of one or more computer-readable storage media, for causing a processor set to perform computer operations that include executing an iteration of an autoregressive generation process of a machine learning model on probability distributions over V values to generate an additional probability distribution for the V values, where V represents a number of tokens in a predefined governing set of tokens, selecting a value with a greatest probability from a first probability distribution for the V values from among the probability distributions for the V values, selecting a second value with a greatest probability from a second probability distribution for the V values from among the probability distributions for the V values, translating the value and the second value to a first output token and a second output token, respectively, based on the predefined governing set of tokens, and generating an output from the machine learning model which includes a sequence of data including the first output token and the second output token. One of the technical advantages of the system is feeding back the entire probability distributions for the tokens in the governing set of tokens during each iteration of the autoregressive generation process. By keeping all of the probability distributions, the next iteration of the autoregressive generation process can explore more answers and result in a more accurate response.

In some embodiments, the computer operations may further include receiving a set of input tokens, generating a set of probability distributions for the set of input tokens, respectively, wherein each probability distribution of the set includes a respective one-hot encoded representation of a respective input token with respect to the V tokens in the predefined governing set of tokens. The technical advantage of this approach is using one-hot encoding during a first iteration of the autoregressive generation process to adapt the input data to a format that can be processed as asset of probability distributions.

In some embodiments, the computer operations may further include embedding the probability distributions for the V values into embeddings, respectively, based on a linear embedding layer which maps a probability distribution for V values into an embedding of E values, where E is a different value than V. The V values of the probability distribution are different in size than the E values of the embeddings. The technical advantage of this step is that it modifies a size of the input data to fit into a next step of the autoregressive generation process.

In some embodiments, the computer operations may further include converting the embeddings into feature embeddings including an additional feature embedding corresponding to a predicted response token via a transformer stack. The technical advantage of this step is that it predicts a token (part of the response) based on multiple embeddings rather than just a single embedding that gives the system more data and results in more accuracy.

In some embodiments, the computer operations may further include converting the additional feature embedding into an additional raw probability distribution over the V tokens of the predefined governing set of tokens based on a linear layer and executing a softmax function on the additional raw probability distribution over the V tokens to generate the additional probability distribution for the V values. The technical effect of this feature is that the softmax function ensures that the sum of the probability distributions for an iteration of the autoregressive generation process is a predefined number (e.g., one, etc.)

In some embodiments, the computer operations may further include executing a next iteration of the autoregressive generation process on the probability distributions for the V values and the additional probability distribution for the V values to generate a further additional probability distribution for the V values. The technical advantage of this step is that it uses the entire probability distribution to generate an additional probability distribution during the autoregressive generation process, whereas related process discard the probability distributions that aren't the greatest among the group.

In some embodiments, the computer operations may further include selecting a third value with a greatest probability from the further additional probability distribution for the V values, and translating the third value to a third output token based on the predefined governing set of tokens. The technical effect of this step is that the answers can be revealed at the end, and not step-by-step because the entire probability distribution is kept, not just the token with the greatest probability. Therefore, more data is used to generate the answer resulting in more accuracy by the process.

Autoregressive generation is a recursive / iterative process for predicting a sequence of data elements, referred to herein as tokens. For example, given a sequence of 1 to N tokens, the autoregressive generation process can predict an N+1 token. Multiple sampling methods can be used for autoregressive generation including, but not limited to, greedy decoding, beam searching, top-k sampling, random sampling, nucleus or top-p sampling, temperature sampling, and the like. One common implementation of an autoregressive generation process utilizes a transformer-based neural network, such as an LLM.

A generative machine learning model often uses, as input, tokens from a governing set of tokens. For example, a transformer model may expect a vocabulary of indices as input. The vocabulary of indices may refer to a vocabulary of data elements and it may be extensive (e.g., hundreds of data elements, thousands of data elements, etc.). A generative model that produces audio may use a governing set of sounds and/or notes as a basis for its audio generation, with each particular sound or note being assigned to a respective token. A generative model that produces images may use a governing set of colors, lines, shapes, and/or object outlines, etc. as a basis for its image generation, with each particular color, line, shape, etc. being assigned to a respective token. For autoregressive tasks that generate words in a language, the vocabulary includes multiple words of one more languages, e.g., one or more words of the English language and/or one or more words of the Spanish language, etc. References throughout this disclosure to a vocabulary are examples of the terminology of a governing set of tokens. Traditionally, the autoregressive generation process identifies a small portion of data elements (e.g., one, three, five, <=, cr, etc.) as potential matches using one of the sampling methods mentioned above, and discards the remaining data elements from the input to the autoregressive generation process. For example, the model may receive an input and may generate a probability for each data element in the vocabulary, referred to herein as a probability distribution.

The probability of each data element represents the likelihood of the respective data element being the solution. The model then selects a few data elements with the greatest probabilities, discarding the remaining data elements from consideration during the autoregressive generation process. However, by discarding the majority of the probabilities, the system loses a significant amount of information which could lead later iterations to a better answer. Furthermore, the discarded probabilities cannot be considered during subsequent iterations of the autoregressive generation process.

The example embodiments are directed to a novel autoregressive generation process which does not discard probabilities but instead relies on the full probability distribution of all elements in the vocabulary for each iteration of the process. The novel autoregressive generation process may be performed by an LLM. For example, rather than selecting a few data elements from the initial probability distribution, the model can use the entire probability distribution as input to the process and considers all data elements in the vocabulary for the next predicted token. Furthermore, the result of the autoregressive generation process is an additional probability distribution for the next token in the sequence, which includes an additional probability distribution over the entire vocabulary of data elements. This process iteratively repeats until all tokens in the sequence have been predicted. Each iteration retains the entire probability distribution from all previous iterations intact, enabling the autoregressive generation process to consider significantly more data and possible answers.

Some of the benefits of the example embodiments include improving the accuracy of a machine learning model performing an autoregressive generation process. By keeping the entire probability distribution for the vocabulary, the process can consider more information in each iteration, and identify possible solutions that would have typically been discarded. In addition, no information is lost through each iteration of the process because the entire/full probability distribution is preserved and used in each subsequent iteration enabling improved accuracy. Furthermore, models that accept and produce full probability distributions, avoiding non-differentiable operations such as ‘max’, can be combined without disrupting gradient flow in backpropagation, for example to form a cycle-GAN. Thus, the present embodiments also include technical improvements for training of a generative machine learning model by improving gradient propagation and subsequent training of the generative model. Computing a loss on the softmax of the logits against 1-hot encoded golden indices can improve the gradient propagation.

The instant features, structures, or characteristics as described throughout this specification may be combined or removed in any suitable manner in one or more embodiments. For example, the usage of the phrases “example embodiments,” “some embodiments,” or other similar language, throughout this specification refers to the fact that a particular feature, structure, or characteristic described in connection with the embodiment may be included in at least one embodiment. Thus, appearances of the phrases “example embodiments,” “in some embodiments,” “in other embodiments,” or other similar language, throughout this specification do not necessarily all refer to the same group of embodiments, and the described features, structures, or characteristics may be combined or removed in any suitable manner in one or more embodiments. Further, in the diagrams, any connection between elements can permit one-way and/or two-way communication even if the depicted connection is a one-way or two-way arrow. Also, any device depicted in the drawings can be a different device. For example, if a mobile device is shown sending information, a wired device could also be used to send the information.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner that is at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

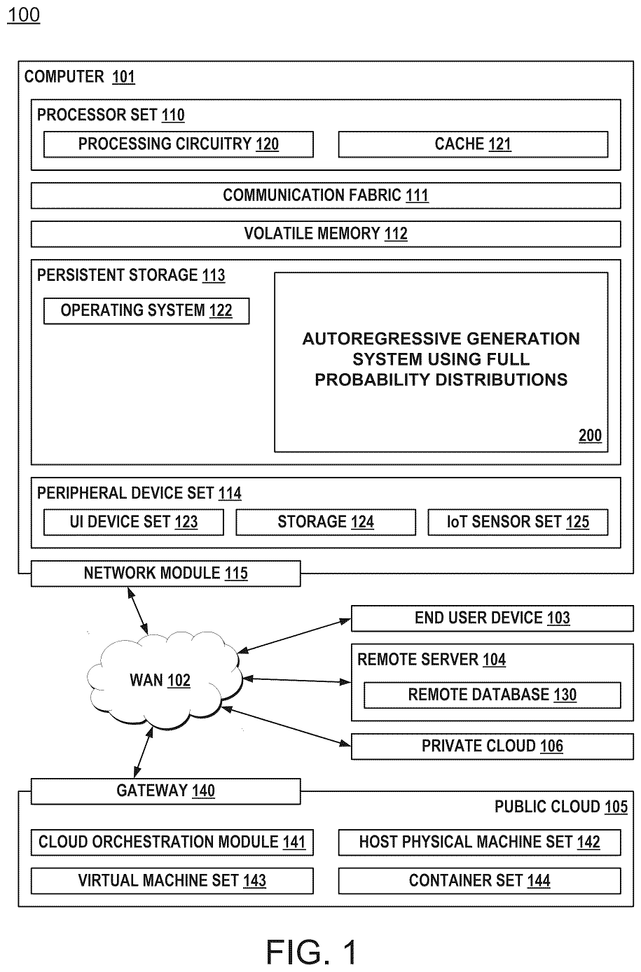

Referring to FIG. 1, computing environment 100 contains an example of an environment for the execution of at least some of the computer code involved in performing the inventive methods, such as autoregressive generation system using full probability distributions (block 200). In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

According to various embodiments, provided is a new type of autoregressive generation system for a machine learning model. With moderate modifications to a model, it is possible to create a transformer that takes full probability distributions over an entire vocabulary as input and produces additional full probability distributions as output. Autoregressive generation can be performed with these full probability distributions. Some of the benefits of this process include no information loss (except rounding errors) because outputs from the previous step are not discarded. Furthermore, the system can eliminate a non-differentiable step of top-k sampling (max⇔top-1) resulting in less information loss during back-propagation. As a result, a more accurate loss computation is possible. Here, the transformer model generates a result that is not ‘collapsed’ to equivalent of 1-hot encoding.

The system described herein can be especially beneficial for situations in which there are multiple tokens with high probabilities of being the answer. In this case, the system can keep all of the information for all of the tokens, enabling multiple additional paths of tokens to be considered by the autoregressive generation process that normally would not be. The use of the entire probability distribution reduces information loss and leads to more accurate predictions for each token in the sequence.

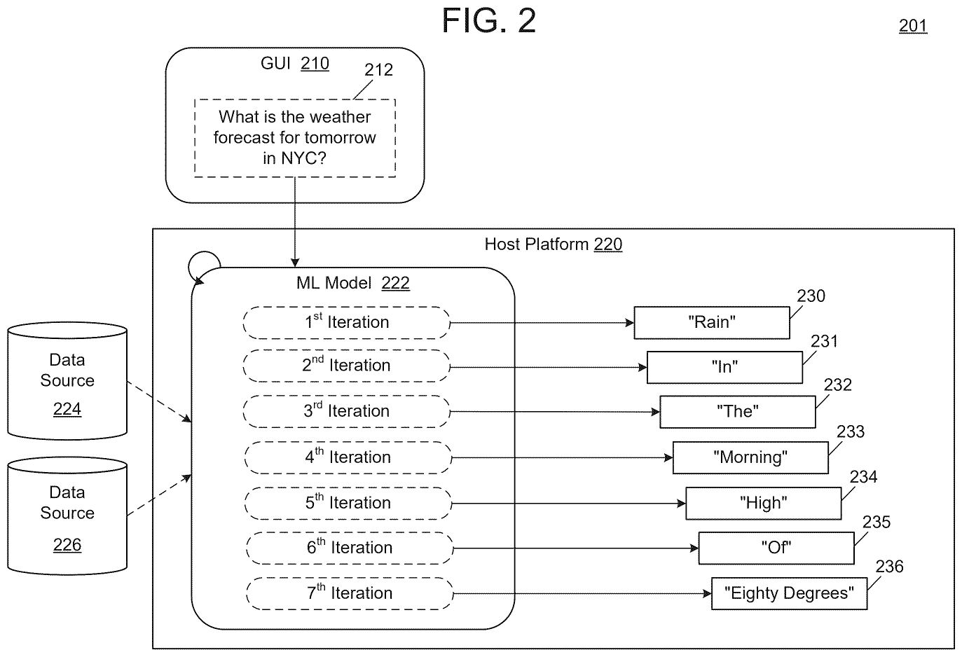

FIG. 2 illustrates a process 201 of a machine learning model 222 performing an autoregressive generation process according to examples and features of the instant solution. The machine learning model 222 may be an AI model, a transformer model, and/or the like. As an example, the machine learning model 222 may be a transformer neural network, such as an LLM. Referring to FIG. 2, a host platform 220 may host a software application (not shown) which includes the machine learning model 222. The host platform 220 may be a cloud platform, a web server, an on-premises server, a distributed system, a hybrid system, and the like. A user may operate a user device to connect to the host platform 220. In response, the host platform 220 may output a graphical user interface 210 on a display screen of the user device. The user may input data and commands to the machine learning model 222 via the graphical user interface 210.

In this example, the user provides an input 212, which is a question being asked of the machine learning model 222. The input 212 may include an input sequence of words that are mapped to tokens in a predefined vocabulary. In response, the machine learning model 222 may utilize autoregressive generation to generate a response to the input 212. The response may include a sequence of tokens output / predicted by the machine learning model 222 including a first predicted token 230, a second predicted token 231, a third predicted token 232, a fourth predicted token 233, a fifth predicted token 234, a sixth predicted token 235, and a seventh predicted token 236, which are predicted by the machine learning model 222 during multiple iterations of the autoregressive generation process.

For example, the machine learning model 222 may receive the input 212 from the graphical user interface 210, and retrieve additional content such as a predefined vocabulary of tokens, any additional data to be ingested (e.g., documents, images, audio, video, etc.), and the like, from data sources 224 and 226, and generate the predicted output. Here, the machine learning model 222 may iteratively perform an autoregressive generation process. During a first iteration of the autoregressive generation process, the machine learning model 222 may predict the first predicted token 230 based on the input 212 and the predefined vocabulary of tokens. During a second iteration, the autoregressive generation process may generate the second predicted token 231 based on the first predicted token 230 and the predefined vocabulary of tokens.

The process may continue for a plurality of additional iterations until a stopping point, such as a limiting criterion, is reached or the answer is fully determined. In some instances, a limiting criterion is a maximum number of tokens reached that the system can handle or an end of sequence token is generated. In this example, a third iteration of the autoregressive generation process generates a third predicted token 232 from the predefined vocabulary of tokens including the first token 230 and the second token 231, a fourth iteration of the autoregressive generation process generates a fourth predicted token 233 from the predefined vocabulary of tokens including the first token 230, the second token 231 and the third token 232, a fifth iteration of the autoregressive generation process generates a fifth predicted token 234 from the predefined vocabulary of tokens including the first token 230, the second token 231, the third token 232 and the fourth token 233, a sixth iteration of the autoregressive generation process generates a sixth predicted token 235 from the predefined vocabulary of tokens including the first token 230, the second token 231, the third token 232, the fourth token 233, and the fifth token 234, and a seventh iteration of the autoregressive generation process generates a seventh predicted token 236 from the predefined vocabulary of tokens including the first token 230, the second token 231, the third token 232, the fourth token 233, the fifth token 234, the sixth token 235, and the seventh token 236. The predicted tokens may be concatenated in sequence by the machine learning model 222 and output as a string of tokens. The output may be displayed on the graphical user interface 210.

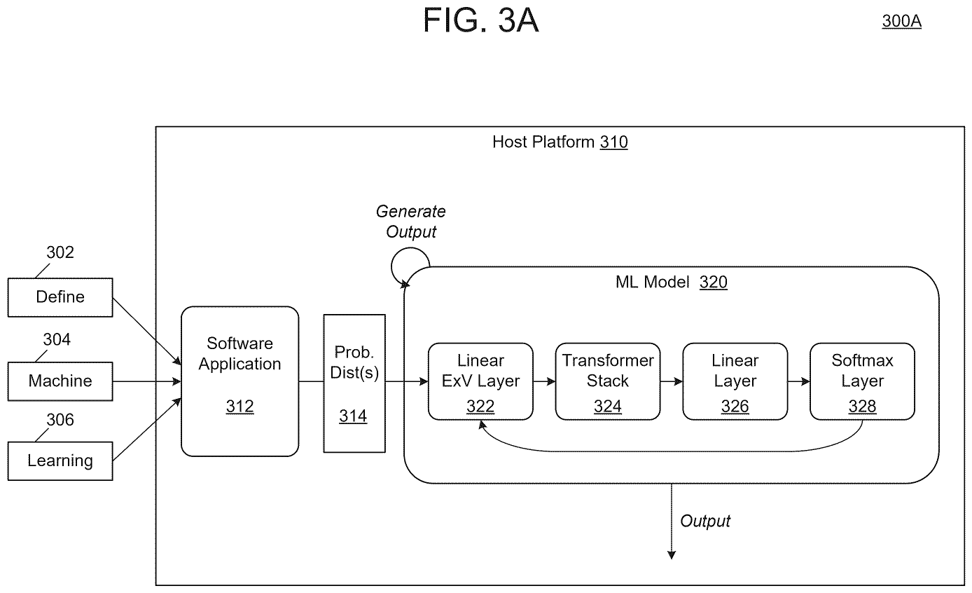

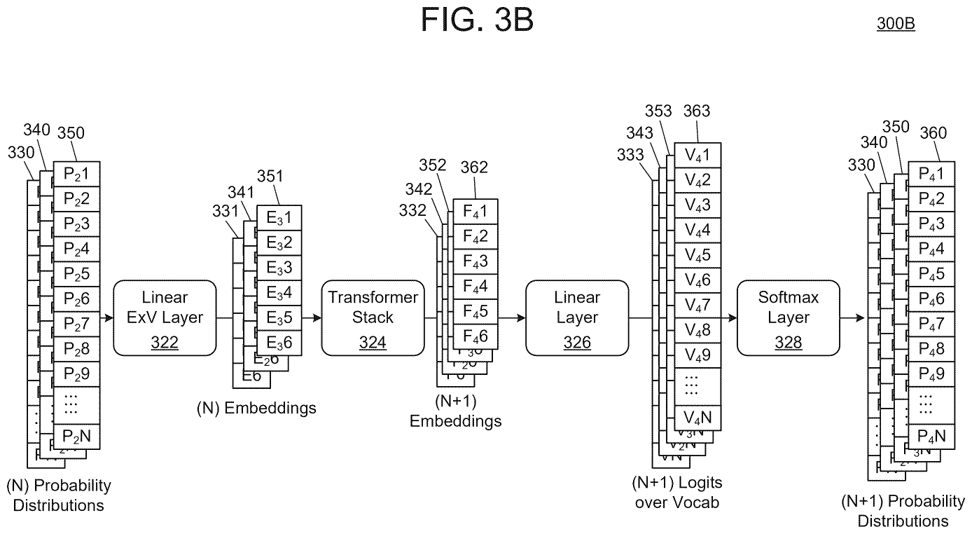

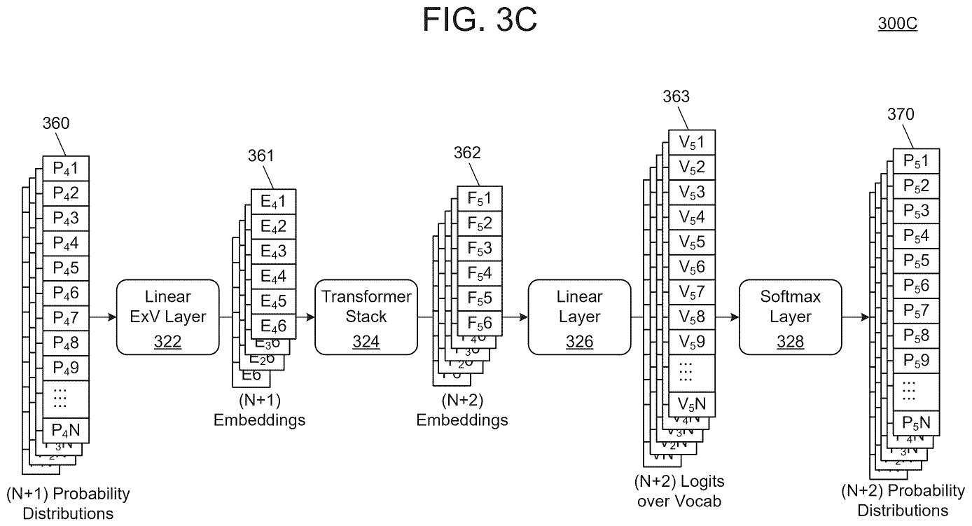

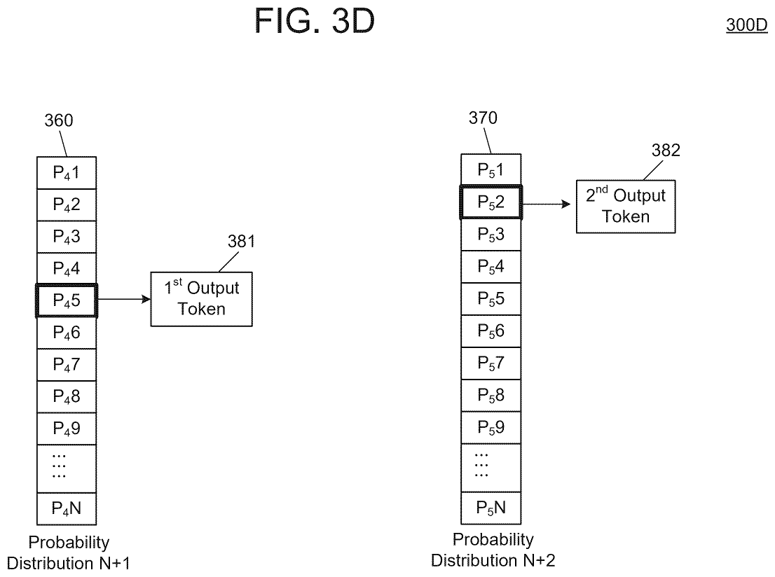

FIGS. 3A-3D are diagrams illustrating examples of the autoregressive generation process that may be performed by the machine learning model 222 during each iteration. For example, FIG. 3A illustrates a process 300A of generating a probability distribution according to examples and features of the instant solution. Referring to FIG. 3A, a host platform 310 hosts a software application 312 which is coupled to a machine learning model 320.

In this example, the machine learning model 320 may correspond to the machine learning model 222 that is shown in the example of FIG. 2. To start the predictive process, the software application 312 may receive an input sequence “define machine learning,” which may be asked or otherwise input by a user of the software application 312. In this example, the input sequence includes three tokens 302, 304, and 306, representing “define”, “machine”, and “learning”, respectively. The software application 312 may generate a respective probability distribution for each token among the three input tokens over a predefined vocabulary from a vocabulary index (not shown) resulting in a sequence of probability distributions 314, referred to herein as N probability distributions where N represents the number of probability distributions in the sequence. Here, the sequence includes three probability distributions (i.e., one probability distribution for each input token). The vocabulary index may be referred to as a governing set of tokens. Each token in the index may receive a probability value of its likelihood of being the next token in the answer/response.

Each probability distribution included in the sequence of N probability distributions 314 will include slots for each token in the vocabulary, which includes V tokens. For example, V tokens may be a large number such as 1000 tokens, 10,000 tokens, 50,000 tokens, etc. However, the only slot that will include a value is the slot corresponding to the input token. For example, the probability distribution for the input token “define” will include a “1” in the slot of the probability distribution that corresponds to the token “define” from the vocabulary, while the other slots in the probability distribution corresponding to the other tokens in the vocabulary will have a value of zero (0). This is referred to as a one-hot encoding. A similar one-hot encoding may be generated for each of the input tokens, resulting in three one-hot encoded probability distributions.

In some embodiments, the sequence of probability distributions 314 may be referred to as an “initial” sequence of probability distributions, which are obtained by tokenizing a ‘prompt’, which may be a question or task that is to be completed. Tokenization breaks the input sequence into pieces for which vocabulary entries exist and thus creates a sequence of vocabulary indices. A ‘1-hot’ representation of a vocabulary index is a pseudo-probability distribution.

The sequence of probability distributions 314 may be input to the machine learning model 320 and used to predict a probability distribution for the first output token (i.e., the first token in the answer/response to the input sequence “define machine learning”). Here, the machine learning model 320 includes a linear E×V layer 322, a transformer stack 324, a linear layer 326, and a softmax layer 328. The linear E×V layer 322 is configured to map a V-dimensional vector (probability distribution over vocabulary) to an internal embedding of dimension E. Thus, the linear E×V layer 322 refers to the size of the matrix: the matrix has E rows and V columns. The linear E×V layer 322 maps a vector of dimension V into a vector of dimension E. The transformer stack 324 passes the internal embedding through a sequence of layers, each a transformer self-attention block, ultimately producing a ‘feature vector’ of an internal dimension, referred to as E. The linear layer 326 maps the feature vector back to a V dimensional vector, a logit distribution over the vocab. The softmax layer 328 then transforms the logit distribution into a probability distribution corresponding to the first output token. The probability distribution includes a probability value (e.g., numerical value) indicating the respective probability that the output token to be generated should be the corresponding member, e.g., word, of the vocabulary. If the vocabulary includes 10,000 words, the probability distribution includes a respective probability value (10,000 probability values) that a respective word should be the next part of the generated sequence.

FIG. 3B illustrates a process 300B of utilizing the sequence of probability distributions (e.g., the probability distributions 314) during an iteration of an autoregressive generation process according to examples and features of the instant solution. Referring to FIG. 3B, the machine learning model 320 may execute the linear E×V layer 322 on the sequence of probability distributions to convert the probability distributions into an embedding. In the example of FIG. 3B, the sequence of N probability distributions 314 shown in FIG. 3A includes three probability distributions 330, 340, and 350 corresponding to the three input tokens “define,” “machine,” and “learning.” During the first iteration of the autoregressive generation process, a fourth probability distribution 360 is generated. The fourth probability distribution 360 corresponds to a first output token (i.e., the answer, response, etc.) to the input tokens. The fourth probability distribution 360 is referred to herein as the N+1 probability distribution.

Here, the number of data values (V) in the probability distributions 330, 340, and 350 may be significantly greater than the number of data values (E) that can fit into an embedding vector generated by the linear E×V layer 322. The linear E×V layer may use a matrix to convert the probability distributions 330, 340, and 350 each with V values therein (dimension V) into an embedding of dimension E, including embeddings 331, 341, and 351. The embeddings 331, 341, and 351 are referred to herein as the embedding of the V values from the probability distribution over the vocabulary into a size of E values, where E is less than V.

The machine learning model 320 may execute the transformer stack 324 on the embeddings 331, 341, and 351 to generate feature embeddings 332, 342, 352, and 362, also referred to herein as embeddings N+1. The transformer stack 324 includes a self-attention layer that predicts the feature embedding 362 corresponding to the first output token. In some embodiments, the feature embeddings 332, 342, and 352 equal the embeddings 331, 341, and 351, respectively, because the transformer stack 324 does not adjust these embeddings but instead analyzes the relationships between the tokens in the one or more input sets of embeddings 331, 341, and 351 to make the prediction for the next token for the answer/response, with the predicted next token being represented by the feature embedding 362. In some embodiments, the transformer stack 324 itself includes another encoder so that along with performing the prediction for the next token the transformer stack 324 also performs an additional transformation of the input embeddings into a dimensional space that is smaller than the dimensional space used for the embeddings 331, 341, 351. Thus, in these embodiments the feature embeddings 332, 342, and 352 are different from the embeddings 331, 341, and 351.

The machine learning model 320 then executes the linear layer 326 on the N+1 feature embeddings 332, 342, 352, and 362 to generate N+1 logits over the vocabulary 333, 343, 353, and 363. The logits, sometimes referred to as activations, refers to a raw data output or raw score from the final layer of the machine learning model. The N+1 logits score includes a raw score for each member of the governing set of tokens, e.g., each member of the vocabulary, and thus has a size of V raw scores. The softmax layer 328 subsequently converts the N+1 logits over the vocabulary 333, 343, 353, and 363 into a probability distribution 360, referred to herein as the probability distribution N+1. The additional probability distribution 360 contains a probability for each data value V in the vocabulary (V tokens), which indicates the likelihood that the token is the output token for this iteration, i.e., the prediction of the next token that follows the input sequence. In this case, the additional probability distribution 360 is not a one-hot encoded representation as are the three probability distributions 330, 340, and 350. Instead, a fractional value is stored in each slot of the additional probability distribution 360 representing the probability of a corresponding token from the vocabulary being the correct token. The softmax layer 328 ensures that the sum of the probabilities in the additional probability distribution 360 adds to 1 (one). This additional probability distribution 360 in at least some embodiments is a vector of floating point values, with floating point rounding errors for the probability values within the vector being the only possible information that is lost for each iteration.

Traditionally, the additional probability distribution 360 would be analyzed to identify the most likely probabilities of the most probable tokens (e.g., top 1 token, top 3 tokens, etc.) and the remaining probabilities from the additional probability distribution 360 would be dropped or otherwise discarded. However, in the example embodiments, the additional probability distribution 360 is fed back in its entirety for the next iteration of the autoregressive generation process thereby preventing information loss and enabling more solutions to be explored by the machine learning model 320. Therefore, if multiple tokens are very similar/close, the machine learning model can explore multiple paths of answers at each iteration in comparison to a traditional autoregressive generation process which discards this extra information.

FIG. 3C illustrates a process 300C of performing a next iteration of the autoregressive generation process according to examples and features of the instant solution. Referring to FIG. 3C, the machine learning model 320 may execute the linear E×V layer 322 on the N+1 probability distributions (e.g., probability distributions 330, 340, 350, and 360 from FIG. 3B) to convert the N+1 probability distributions into N+1 embeddings, including an embedding 361 corresponding to the additional probability distribution 360. As previously mentioned, the number of data values V in each of the probability distributions may be significantly greater than a number of data values E that can fit into an embedding vector generated by the linear E×V layer 322. The E×V layer may use a matrix to convert the probability distribution with the V data values into an embedding with E data values in vector space, where E is less than V.

The machine learning model 320 may execute the transformer stack 324 on the N+1 embeddings (including on embedding 361) to generate N+2 feature embeddings including a feature embedding 362 corresponding to the next predicted output token (N+2). Next, the machine learning model 320 executes the linear layer 326 on the N+2 feature embeddings (including on the feature embedding 362) to generate N+2 logits over the vocabulary for the N+2 embeddings including a logit over the vocabulary 363 corresponding to the next predicted output token. Next, the softmax layer 328 converts the N+2 logits over the vocabulary (including the logit over the vocabulary 363) into N+2 probability distributions including an additional probability distribution 370, referred to herein as probability distribution N+2. The additional probability distribution 370 contains the probability of each data value in the vocabulary being the second output token for the response to the initial query input. In at least some embodiments, in additional iterations like the iteration described in FIG. 3C some of the embeddings and logits and probability distributions are saved from one or more previous iterations and do not need to be recalculated. Although of course the various components newly analyze the received information to newly compute the N+X embeddings, the N+X+1 embeddings with a new token prediction set of embeddings, and the N+X+1 logits, and the N+X+1 probability distribution.

This same process shown in FIGS. 3B and 3C, may be repeated until all of the predicted output tokens are generated, where each iteration adds an additional predicted token based on the previous predicted tokens utilizing full distribution values of the vocabulary.

FIG. 3D illustrates a process 300D of selecting tokens for output by the machine learning model according to the examples and features of the instant solution. Traditionally, a machine learning model will select the predicted token after each iteration of the autoregressive generation process. However, in the example embodiments, there is no need to select the predicted token after each iteration, because all of the probabilities of all of the probability distributions are preserved, and can be analyzed at the end of the iterative process (e.g., after the last iteration, etc.).

Referring to FIG. 3D, the machine learning model 320 may analyze each of the probability distributions that are iteratively generated by the autoregressive generation process, and select a token from each probability distribution, generate a sequence of predicted tokens from the selected tokens, and output the sequence of predicted tokens. For example, the machine learning model 320 may select a token 381 as a first predicted token from the N+1 probability distribution 360. Here, the token 381 may be the token with the greatest probability value. The machine learning model 320 may also select a token 382 from the N+2 probability distribution 370. The token 382 may be the token with the greatest probability in the N+2 probability distribution 370. The selected tokens may be concatenated (e.g., the token 381, the token 382, etc.), and output by the machine learning model 320 as a response to the input sequence of tokens. In at least some embodiments, this analysis of the sequence of probability distributions to find the highest probable token for each step of the output sequence is considered a greedy decoding, but a greedy coding that occurs after all predictions of the transformer stack have been made and/or after all probability distributions (one for each token of the response/answer) have been produced.

Here, the machine learning model 320 can wait to generate the predicted tokens until all iterations of the autoregressive generation process have been performed.

In at least some embodiments, the generative machine learning model that is used to perform the generative task using an iterative passback of a full probability distribution as described herein receives augmented training by using ground truth probability distributions (as opposed to 1-hot encodings) that result in a correct golden sequence regarding a metric such as L1 or L2 as labeled training data. A correct golden sequence also is referred to as a ground truth output, e.g., a correct response/answer to a query. In at least some embodiments, the ground truth probability distributions refer to one or more probability distributions that are within a certain predefined margin from the 1-hot encoding of the correct golden sequence. Such predicted probability distribution targets may be replaced with improved predictions as the model improves.

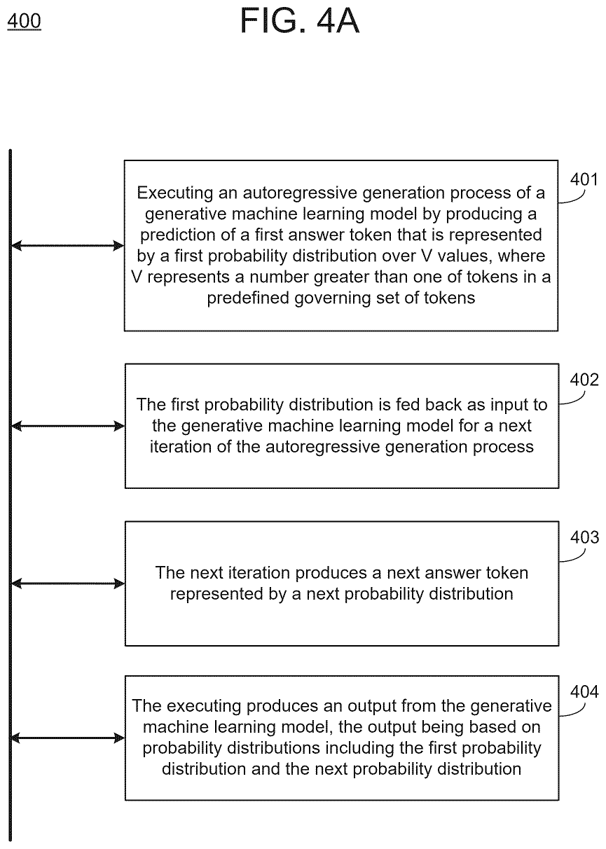

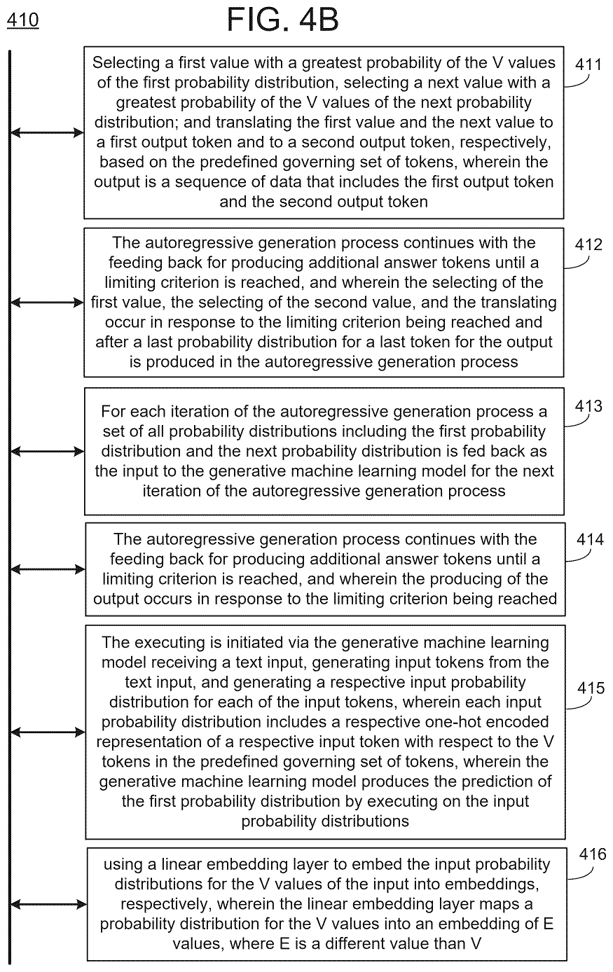

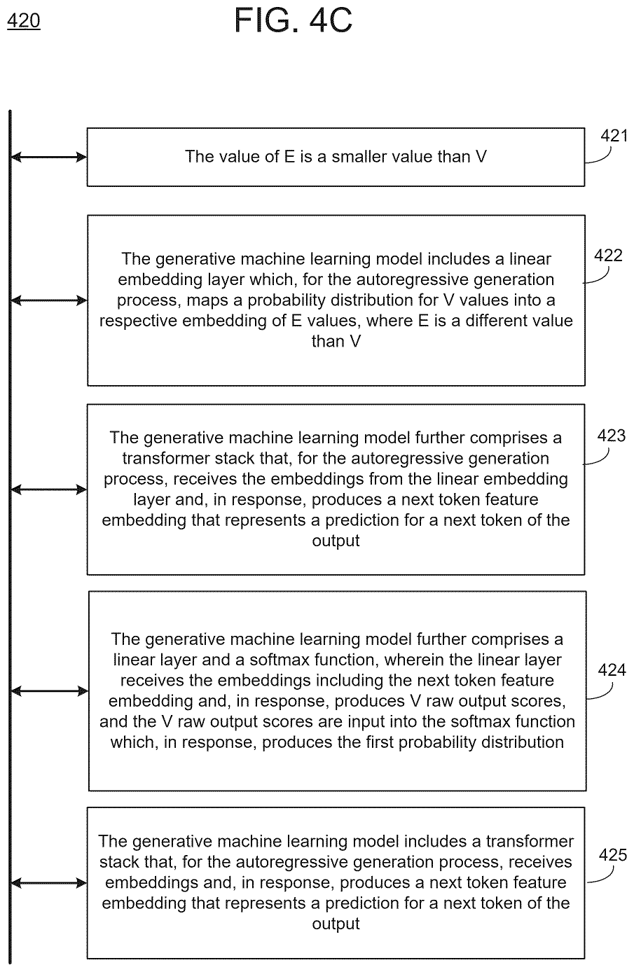

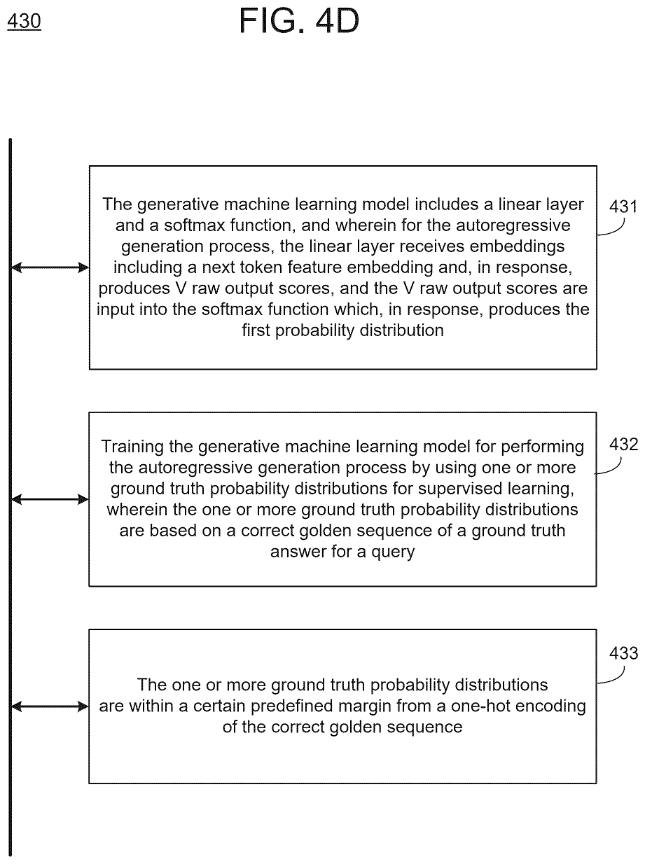

FIG. 4A illustrates a flow diagram of a method 400, according to example embodiments. Referring to FIG. 4A, in 401, the method may include executing an autoregressive generation process of a generative machine learning model by producing a prediction of a first answer token that is represented by a first probability distribution over V values, where V represents a number greater than one of tokens in a predefined governing set of tokens. In 402, the first probability distribution is fed back as input to the generative machine learning model for a next iteration of the autoregressive generation process. In 403, the next iteration produces a next answer token represented by a next probability distribution. In 404, the executing produces an output from the generative machine learning model, the output being based on probability distributions including the first probability distribution and the next probability distribution.

FIG. 4B illustrates a flow diagram of a method 410, according to example embodiments. Referring to FIG. 4B, in 411, the method may include selecting a first value with a greatest probability of the V values of the first probability distribution, selecting a next value with a greatest probability of the V values of the next probability distribution; and translating the first value and the next value to a first output token and to a second output token, respectively, based on the predefined governing set of tokens, wherein the output is a sequence of data that includes the first output token and the second output token. In 412, the autoregressive generation process continues with the feeding back for producing additional answer tokens until a limiting criterion is reached, and wherein the selecting of the first value, the selecting of the second value, and the translating occur in response to the limiting criterion being reached and after a last probability distribution for a last token for the output is produced in the autoregressive generation process.

In 413, for each iteration of the autoregressive generation process a set of all probability distributions including the first probability distribution and the next probability distribution is fed back as the input to the generative machine learning model for the next iteration of the autoregressive generation process. In 414, the autoregressive generation process continues with the feeding back for producing additional answer tokens until a limiting criterion is reached, and wherein the producing of the output occurs in response to the limiting criterion being reached.

In 415, the executing is initiated via the generative machine learning model receiving a text input, generating input tokens from the text input, and generating a respective input probability distribution for each of the input tokens, wherein each input probability distribution includes a respective one-hot encoded representation of a respective input token with respect to the V tokens in the predefined governing set of tokens, wherein the generative machine learning model produces the prediction of the first probability distribution by executing on the input probability distributions. In 416, the method includes using a linear embedding layer to embed the input probability distributions for the V values of the input into embeddings, respectively, wherein the linear embedding layer maps a probability distribution for the V values into an embedding of E values, where E is a different value than V. In 417, the value of E is a smaller value than V.

FIG. 4C illustrates a flow diagram of a method 420, according to example embodiments. Referring to FIG. 4C, in 421, the value of E is a smaller value than V. In 422, the generative machine learning model includes a linear embedding layer which, for the autoregressive generation process, maps a probability distribution for V values into a respective embedding of E values, where E is a different value than V. In 423, the generative machine learning model further comprises a transformer stack that, for the autoregressive generation process, receives the embeddings from the linear embedding layer and, in response, produces a next token feature embedding that represents a prediction for a next token of the output.

In 424, the generative machine learning model further comprises a linear layer and a softmax function, wherein the linear layer receives the embeddings including the next token feature embedding and, in response, produces V raw output scores, and the V raw output scores are input into the softmax function which, in response, produces the first probability distribution. In 425, the generative machine learning model includes a transformer stack that, for the autoregressive generation process, receives embeddings and, in response, produces a next token feature embedding that represents a prediction for a next token of the output.

FIG. 4D illustrates a flow diagram of a method 430, according to example embodiments. Referring to FIG. 4D, in 431, the generative machine learning model includes a linear layer and a softmax function, and wherein for the autoregressive generation process, the linear layer receives embeddings including a next token feature embedding and, in response, produces V raw output scores, and the V raw output scores are input into the softmax function which, in response, produces the first probability distribution.

In 432, the method includes training the generative machine learning model for performing the autoregressive generation process by using one or more ground truth probability distributions for supervised learning, wherein the one or more ground truth probability distributions are based on a correct golden sequence of a ground truth answer for a query. In 433, the one or more ground truth probability distributions are within a certain predefined margin from a one-hot encoding of the correct golden sequence.

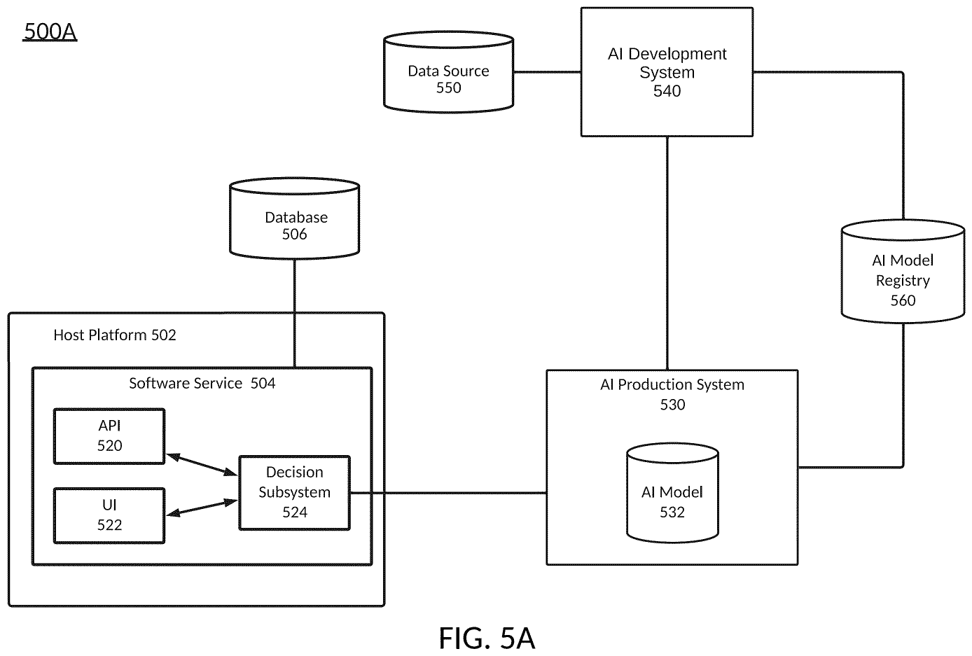

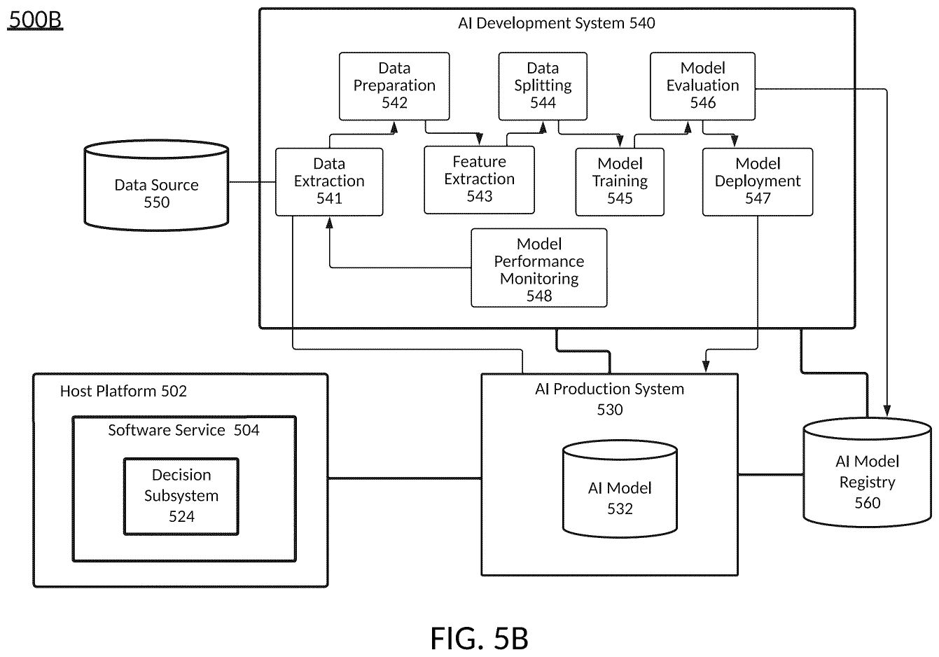

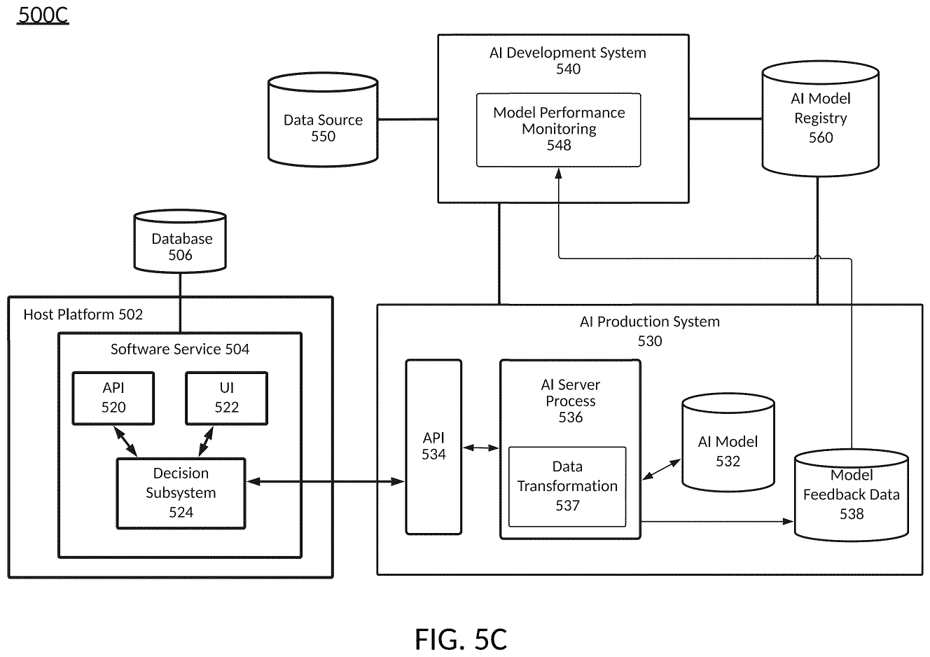

Detailed descriptions of training a machine learning model and executing a machine learning model are further described and depicted herein. The training and execution of the machine learning model described in the examples of FIGS. 5A-5C may be performed inside a confidential machine learning computing environment as described in the examples herein.

FIG. 5A illustrates an artificial intelligence (AI) network diagram 500A that supports AI-assisted decision points in a software service executing on a computer. As one example, the AI model being trained in the examples herein may refer to an AI model for any of the tasks performed herein including a machine learning model, a neural network, a large language model (LLM), and the like. While the example instant solution shown utilizes a neural network, which is a type of machine learning (ML) model, other branches of AI, such as, but not limited to, computer vision, fuzzy logic, expert systems, deep learning, generative AI, and natural language processing, may be employed in developing the AI model in this instant solution. Further, the AI model included in these examples and features of the instant solution is not limited to particular AI algorithms. Any algorithm or combination of algorithms related to supervised, unsupervised, and reinforcement learning may be employed.

The AI models, ML models, neural networks, and other branches of AI, described and/or depicted herein, build upon the fundamentals of predecessor technologies and form the foundation for all future technological advancements in artificial intelligence. An AI classification system describes the stages of AI progression and advancement. The first classification is known as “reactive machines,” followed by present-day AI classification “limited memory machines” (also known as “artificial narrow intelligence”), then progressing to “theory of mind” (also known as “artificial general intelligence”) and reaching the AI classification “self-aware” (also known as “artificial superintelligence”). Present-day limited memory machines are a growing group of AI models built upon the foundation of their predecessors, reactive machines. Reactive machines emulate human responses to stimuli; however, they are limited in their capabilities as they cannot typically learn from prior experience. Once the AI model's learning abilities emerged, its classification was promoted to limited memory machines. In this present-day classification, AI models learn from large volumes of data, detect patterns, solve problems, generate, and predict data, and the like, while inheriting all the capabilities of reactive machines.

Examples of AI models classified as limited memory machines include, but are not limited to, chatbots, virtual assistants, machine learning, neural networks, deep learning, natural language processing, generative AI models, and any future AI models that are yet to be developed possessing characteristics of limited memory machines.

For example, a neural network is a type of machine learning model that relies on training data to learn associations and connections, improving its accuracy for performing high speed data classifications, clustering, and other analyses of data. Such neural network capabilities are the foundation of deep learning models today as well as becoming the foundational blocks of those yet to be developed.

For example, generative AI models combine limited memory machine technologies, incorporating machine learning and deep learning, forming the foundational building blocks of future AI models. For example, theory of mind is the next progression of AI that may be able to perceive, connect, and react by generating appropriate reactions in response to an entity with which the AI model is interacting; all these theory of mind capabilities rely on the fundamentals of generative AI. Furthermore, in an evolution into the self-aware classification, AI models will be able to understand and evoke emotions in the entities they interact with, as well as possessing their own emotions, beliefs, and needs, all of which rely on generative AI fundamentals of learning from experiences to generate and draw conclusions about itself and its surroundings.

AI models may include, but are not limited to, at least one machine learning model, neural network model, deep learning model, generative AI model, or any combination of models from the branches of AI. AI models are integral and core to future artificial intelligence models. As described herein, AI model refers to present-day AI models and future AI models.

Artificial intelligence systems have been built and trained to perform various tasks in an automated manner. For example, artificial intelligence systems receive and understand verbal and/or written dialogue and function as digital assistants, speech-to-text programs, etc. Other artificial intelligence systems are trained on different types of information to allow the trained system to generate content—such as new works of art based on the styles seen, or new compound ideas based on the history of chemical research.

Foundation models are types of artificial intelligence systems that are trained on a broad set of unlabeled data that can be used for different tasks, with minimal fine-tuning. The unlabeled data includes in some instances imagery and/or language. In response to a short prompt being input into the foundation model, the system generates an output such as an entire essay, or a complex image, based on the parameters that are set forth in the input prompt. The foundation model is able to produce an output that attempts to meet the parameters even if the foundation model was never trained with specific training data that included the exact parameters, e.g., was never trained for that exact argument or to generate an image in that way.

Using self-supervised learning and transfer learning, foundation models can apply information that they have learnt about one situation to another. For example, like a human learns how to drive on one car, for example, and without too much effort, could learn how to drive other types of vehicles such as other cars, a truck, or a bus. The foundation model similarly is used to achieve proficiency in some new area without having to be trained completely from scratch. Foundation models seem to have inherent creativity in performing tasks such as stringing together coherent arguments or creating entirely original pieces of art. Foundation models are established in the technology of natural-language processing. One example of how foundation models are helpful is that for previous generation of AI techniques, if you wanted to build an AI model that could summarize bodies of text for you, you would need tens of thousands of labeled examples just for the summarization use case. With a pre-trained foundation model, the labeled data requirements are dramatically reduced. First, the foundation model is fine-tuned with a domain-specific unlabeled corpus to create a domain-specific foundation model. Then, using a much smaller amount of labeled data, potentially just a thousand labeled examples, a foundation model is trained for summarization. The domain-specific foundation model can be used for many tasks as opposed to the previous technologies that required building models from scratch in each use case. Foundation models are even applicable in areas such as computer programming coding analysis, generation, and repair.

Some foundation models are used for sentiment analysis. With pre-trained foundation models, sentiment analysis on a new language can be trained using as little as a few thousand sentences—100 times fewer annotations required than previous models. Reducing labeling requirements will make it much easier for implementation in various technical areas. Systems that execute specific tasks in a single domain are giving way to broad AI that learns more generally and works across domains and problems. Foundation models, trained on large, unlabeled datasets and fine-tuned for an array of applications, are driving this shift.

Large language models (LLMs) are a category of foundation models trained on immense amounts of data making them capable of understanding and generating natural language and other types of content to perform a wide range of tasks. LLMs have been implemented at different levels to enhance their natural language understanding (NLU) and natural language processing (NLP) capabilities. This advancement of LLMs has occurred alongside advances in machine learning, machine learning models, algorithms, neural networks and the transformer models that provide the architecture for these AI systems.

LLMs are a class of foundation models, which are trained on enormous amounts of data to provide the foundational capabilities needed to drive multiple use cases and applications, as well as resolve a multitude of tasks. This LLM concept is in stark contrast to the idea of building and training domain specific models for each of these use cases individually, which is prohibitive under many criteria (most importantly cost and infrastructure), stifles synergies and can even lead to inferior performance.

LLMs represent a significant breakthrough in NLP and artificial intelligence. LLMs are accessible through interfaces like Open AI's Chat GPT-3 and GPT-4, which have garnered the support of Microsoft. Other examples include Meta's Llama models and Google's bidirectional encoder representations from transformers (BERT/RoBERTa) and PaLM models. IBM has also recently launched its Granite model series on watsonx.ai, which has become the generative AI backbone for other IBM products like watsonx Assistant and watsonx Orchestrate.

In a nutshell, LLMs are designed to understand and generate text like a human, in addition to other forms of content, based on the vast amount of data used to train them. They have the ability to infer from context, generate coherent and contextually relevant responses, translate to languages other than English, summarize text, answer questions (general conversation and FAQs) and even assist in creative writing or code generation tasks. LLMs are able to do some or all of these tasks thanks to many, e.g., billions of, parameters that enable them to capture intricate patterns in language and perform a wide array of language-related tasks. LLMs are revolutionizing applications in various fields, from chatbots and virtual assistants to content generation, research assistance and language translation.

LLMs operate by leveraging deep learning techniques and vast amounts of textual data. These models are typically based on a transformer architecture, like the generative pre-trained transformer, which excels at handling sequential data like text input. LLMs consist of multiple layers of neural networks, each with parameters that can be fine-tuned during training, which are enhanced further by a numerous layer known as the attention mechanism, which dials in on specific parts of data sets.

During the training process, these models learn to predict the next word in a sentence based on the context provided by the preceding words. The model does this through attributing a probability score to the recurrence of words that have been tokenized—broken down into smaller sequences of characters. These tokens are then transformed into embeddings, which are numeric representations of this context.

To ensure accuracy, this process involves training the LLM on a large corpus of text (e.g., in the billions of pages), allowing the LLM to learn grammar, semantics and conceptual relationships through zero-shot and self-supervised learning. Once trained on this training data, LLMs can generate text by autonomously predicting the next word based on the input they receive, and drawing on the patterns and knowledge they have acquired. The result is coherent and contextually relevant language generation that can be harnessed for a wide range of NLU and content generation tasks.

Model performance can also be increased through prompt engineering, prompt-tuning, fine-tuning and other tactics like reinforcement learning with human feedback (RLHF) to remove the biases, hateful speech and factually incorrect answers known as “hallucinations” that are often unwanted byproducts of training on so much unstructured data. LLMs augment conversational AI in chatbots and virtual assistants to enhance the interactions that provide context-aware responses that mimic interactions with human agents.

LLMs also excel in content generation, automating content creation for blog articles, explanatory materials, and other writing tasks. LLMs aid in summarizing and extracting information from vast datasets, accelerating knowledge discovery. LLMs also play a vital role in language translation, breaking down language barriers by providing accurate and contextually relevant translations. LLMs can even be used to write code, or “translate” between programming languages. LLMs contribute to accessibility by assisting individuals with disabilities, including text-to-speech applications and generating content in accessible formats.

LLMs often include abilities such as:
Text generation: language generation abilities, such as writing emails, blog posts or other mid-to-long form content in response to prompts that can be refined and polished. An excellent example is retrieval-augmented generation (RAG).
Content summarization: summarize long articles, news stories, research reports, corporate documentation and even interaction history into thorough texts tailored in length to the output format.
AI assistants: chatbots that answer queries, perform backend tasks and provide detailed information in natural language as a part of an integrated, self-serve solution for handling inquiries.
Code generation: assists developers in building applications, finding errors in code and uncovering security issues in multiple programming languages, even “translating” between them.
Sentiment analysis: analyze text to determine a user's tone in order to understand user feedback at scale and aid in brand reputation management.
Language translation: provides wider coverage to organizations across languages and geographies with fluent translations and multilingual capabilities.

Software service 504 (see FIG. 5A), executing on host platform 502 (see FIG. 5A) may provide one or more application programming interfaces (APIs) 520 that enable interaction with other software components via a set of data definitions and protocols. In some examples and features of the instant solution, the APIs provided may employ Simple Object Access Protocol (SOAP), Remote Procedure Calls (RPC), and Representational State Transfer (REST) techniques. In some examples and features of the instant solution, the plurality of APIs 520 send data to one or more decision subsystems 524 of the software service 504 to assist in decision-making. In some examples and features of the instant solution, the software service 504 stores data included in API requests or data generated during processing the API requests into one or more databases 506 (see FIG. 5A).

Software service 504 may provide one or more user interfaces (UIs) 522, such as a server-side hosted graphical user interface (GUI). In some examples and features of the instant solution, the UIs 522 provided employ template-based frameworks, component-based frameworks, etc. In some examples and features of the instant solution, these UIs 522 send data to one or more decision subsystems 524 of the software service 504 to assist with decision-making. In some examples and features of the instant solution, the software service 504 stores data included in UI requests or data generated during processing the UI requests into one or more databases 506.

Software service 504 may include one or more decision subsystems 524 that drive a decision-making process of the software service 504. In some examples and features of the instant solution, the decision subsystems 524 receive data from one or more APIs 520 as input into the decision-making process. In some examples and features of the instant solution, a decision subsystem 524 may receive data from one or more UIs 522 as input to the decision-making process. A decision subsystem 524 may gather service configuration or historical execution data from one or more databases 506 to aid in the decision-making process. A decision subsystem 524 may provide feedback to an API 520 or a UI 522.

An AI production system 530 may be used by a decision subsystem 524 in a software service 504 to assist in its decision-making process. The AI production system 530 includes one or more AI models 532 that are executed to generate a response, such as, but not limited to, a prediction, a categorization, a UI prompt, etc. In some examples and features of the instant solution, an AI production system 530 is hosted on a server. In some examples and features of the instant solution, the AI production system 530 is cloud-hosted. In some examples and features of the instant solution, the AI production system 530 is deployed in a distributed multi-node architecture.

An AI development system 540 creates one or more AI models 532. In some examples and features of the instant solution, the AI development system 540 utilizes data from one or more data sources 550 to develop and train one or more AI models 532. The data sources 550 may be local or third-party data sources. Further, the data provided by the data sources may be real-world or synthetic. In some examples and features of the instant solution, the AI development system 540 utilizes feedback data from one or more AI production systems 530 for new model development and/or existing model re-training. In some examples and features of the instant solution, the AI development system 540 resides and executes on a server. In some examples and features of the instant solution, the AI development system 540 is cloud hosted. In some examples and features of the instant solution, the AI development system 540 is deployed in a distributed multi-node architecture. In some examples and features of the instant solution, the AI development system 540 utilizes a distributed data pipeline/analytics engine.

Once an AI model 532 has been trained and validated in the AI development system 540, it may be stored in an AI model registry 560 for retrieval by either the AI development system 540 or by one or more AI production systems 530. The AI model registry 560 resides in a dedicated server in one example of the instant solution. In some examples and features of the instant solution, the AI model registry 560 is cloud-hosted. In some examples and features of the instant solution, the AI model registry 560 resides in the AI production system 530. In some examples and features of the instant solution, the AI model registry 560 is a distributed database.

FIG. 5B illustrates a process 500B for developing one or more AI models that support AI-assisted decision points. An AI development system 540 executes steps to develop an AI model 532 that begins with data extraction 541, in which data is loaded and ingested from one or more data sources 550. In some examples and features of the instant solution, historical model feedback data is extracted from one or more AI production systems 530.

Once the data has been extracted during data extraction 541, it undergoes data preparation 542 for model training. In some examples and features of the instant solution, this step involves statistical testing of the data to see how well it reflects real-world events, its distribution, the variety of data in the dataset, etc., and the results of this statistical testing may lead to one or more data transformations being employed to normalize one or more values in the dataset. In some examples and features of the instant solution, data deemed to be noisy is cleaned. A noisy dataset includes values that do not contribute to the training, such as, but not limited to, null and long string values. Data preparation 542 may be a manual process or an automated process using one or more of the elements and/or functions described and/or depicted herein.

Features of the data are identified and extracted during the feature extraction step 543. In some examples and features of the instant solution, a feature of the data is internal to the prepared data from the data preparation step 542. In some examples and features of the instant solution, a feature of the data requires a piece of prepared data from the data preparation step 542 to be enriched by data from another data source to be useful in developing the AI model 532. In some examples and features of the instant solution, identifying relevant features (relevant attributes) for model training are performed via an automated process using one or more of the elements and/or functions described and/or depicted herein. Once the features have been identified, the values of the features are collected into a dataset that will be used to develop the AI model 532.

The dataset output from the feature extraction step 543 is split 544 into a training and validation data set. The training data set is used to train the AI model 532, and the validation data set is used to evaluate the performance of the AI model 532 on unseen data.

The AI model 532 is trained and tuned 545 using the training data set from the data splitting step 544. In this step, the training data set is provided to an AI algorithm and an initial set of algorithm parameters which may be automatically determined based on the interdependence between the relevant attributes determined according to various embodiments. The performance of the AI model 532 is then tested within the AI development system 540 utilizing the validation data set from step 544. These steps may be repeated with adjustments to one or more algorithm parameters until the model's performance is acceptable based on various goals and/or results.

The AI model 532 is evaluated 546 in a staging environment (not shown) that resembles the target AI production system 530. This evaluation uses a validation dataset to ensure the performance in an AI production system 530 matches or exceeds expectations. In some examples and features of the instant solution, the validation dataset from step 544 is used. In some examples and features of the instant solution, one or more unseen validation datasets are used. In some examples and features of the instant solution, the staging environment is part of the AI development system 540, and the staging environment is managed separately from the AI development system 540. Once the AI model 532 has been validated, it is stored in an AI model registry 560, where it can be retrieved for deployment and future updates. In some examples and features of the instant solution, the model evaluation step 546 may be a manual process or an automated process using one or more of the elements and/or functions described and/or depicted herein.

In some examples and features of the instant solution, the AI development system includes a user interface (not shown). The user interface may be used to manage the development system infrastructure, the steps 541-548 within the development system, the interim data transmitted between the various steps 541-548, and the data sources 550.

Once an AI model 532 has been validated and published to an AI model registry 560, it may be deployed during the model deployment step 547 to one or more AI production systems 530. In some examples and features of the instant solution, the performance of deployed AI model 532 is monitored 548 by the AI development system 540. In some examples and features of the instant solution, AI model 532 feedback data is provided by the AI production system 530 to enable model performance monitoring 548, and the AI development system 540 periodically requests feedback data for model performance monitoring 548, which includes one or more triggers that result in the AI model 532 being updated by repeating steps 541-548 with updated data from one or more data sources 550.

FIG. 5C illustrates a process 500C for utilizing an AI model that supports AI-assisted decision points. As stated previously, the AI model utilization process depicted herein reflects ML, which is a particular branch of AI, but this instant solution is not limited to ML and is not limited to any AI algorithm or combination of algorithms.

Referring to FIG. 5C, an AI production system 530 may be used by a decision subsystem 524 in software service 504 to assist in its decision-making process. The AI production system 530 provides an API 534, executed by an AI server process 536 through which requests can be made. In some examples and features of the instant solution, a request may include an AI model 532 identifier to be executed based on the type of request. In some examples and features of the instant solution, a data payload (e.g., to be input to the AI model during execution) is included in the request. The data payload may include API 520 data from software service 504, UI 522 data from software service 504 or data from other software service 504 subsystems (not shown).

Upon receiving the API 534 request, the AI server process 536 may transform 537 the data payload or portions of the data payload to be valid feature values in an AI model 532. Data transformation 537 may include, but is not limited to, combining data values, normalizing data values, and enriching the incoming data with data from other data sources 550. Once the data transformation occurs, the AI server process 536 executes the appropriate AI model 532 using the transformed input data. Upon receiving the execution result, the AI server process 536 responds to the API requester, which is a decision subsystem 524 of software service 504. In some examples and features of the instant solution, the response may result in an update to a UI 522 in software service 504. In some examples and features of the instant solution, the response includes a request identifier that can be used later by the software service 504 to provide feedback on the performance of the AI model 532. In some examples and features of the instant solution, a model feedback record may be added into a model feedback data 538 by the AI server process 536.

In some examples and features of the instant solution, the API 534 includes an interface to provide AI model 532 feedback after an AI model 532 execution response has been processed. This mechanism enables the requester to provide feedback on the accuracy of the AI model 532 results. In some examples and features of the instant solution, the feedback interface includes the identifier of the initial request so that it can be used to associate the feedback with the request. Upon receiving a call into the feedback interface of the API 534, the AI server process 536 creates and adds a model feedback record into the model feedback data 538 which holds historical model feedback records. In some examples and features of the instant solution, the records in this model feedback data 538 are provided to model performance monitoring 548 in the AI development system 540. This model feedback data is streamed to the AI development system 540 or may be provided upon request. In some examples and features of the instant solution, the model feedback records in the model feedback data 538 are used as an input for retraining the AI model 532.

In some examples and features of the instant solution, the AI production system 530 includes a user interface (not shown). The user interface may be used to manage the production system infrastructure, the components of the production system 530-538, and the operation of the AI production system and its components.

The above embodiments may be implemented in hardware, in a computer program executed by a processor, in firmware, or in a combination of the above. A computer program may be embodied on a computer-readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

An exemplary storage medium may be coupled to the processor such that the processor may read information from, and write information to, the storage medium. In the alternative, the storage medium may be integral to the processor. The processor and the storage medium may reside in an application-specific integrated circuit (“ASIC”). In the alternative, the processor and the storage medium may reside as discrete components.

What is claimed is:

1. A method comprising:
executing an autoregressive generation process of a generative machine learning model by producing a prediction of a first answer token that is represented by a first probability distribution over V values, where V represents a number greater than one of tokens in a predefined governing set of tokens,
wherein the first probability distribution is fed back as input to the generative machine learning model for a next iteration of the autoregressive generation process,
wherein the next iteration produces a next answer token represented by a next probability distribution, and
wherein the executing produces an output from the generative machine learning model, the output being based on probability distributions including the first probability distribution and the next probability distribution.

2. The method of claim 1, wherein the executing further comprises:
selecting a first value with a greatest probability of the V values of the first probability distribution;
selecting a next value with a greatest probability of the V values of the next probability distribution; and
translating the first value and the next value to a first output token and to a second output token, respectively, based on the predefined governing set of tokens;
wherein the output is a sequence of data that includes the first output token and the second output token.

3. The method of claim 2, wherein the autoregressive generation process continues with the feeding back for producing additional answer tokens until a limiting criterion is reached, and wherein the selecting of the first value, the selecting of the second value, and the translating occur in response to the limiting criterion being reached and after a last probability distribution for a last token for the output is produced in the autoregressive generation process.

4. The method of claim 1, wherein for each iteration of the autoregressive generation process a set of all probability distributions including the first probability distribution and the next probability distribution is fed back as the input to the generative machine learning model for the next iteration of the autoregressive generation process.

5. The method of claim 1, wherein the autoregressive generation process continues with the feeding back for producing additional answer tokens until a limiting criterion is reached, and wherein the producing of the output occurs in response to the limiting criterion being reached.

6. The method of claim 1, wherein the executing is initiated via the generative machine learning model:
receiving a text input;
generating input tokens from the text input; and
generating a respective input probability distribution for each of the input tokens, wherein each input probability distribution includes a respective one-hot encoded representation of a respective input token with respect to the V tokens in the predefined governing set of tokens;
wherein the generative machine learning model produces the prediction of the first probability distribution by executing on the input probability distributions.

7. The method of claim 6, wherein the executing on the input probability distributions comprises using a linear embedding layer to embed the input probability distributions for the V values of the input into embeddings, respectively, wherein the linear embedding layer maps a probability distribution for the V values into an embedding of E values, where E is a different value than V.

8. The method of claim 7, wherein E is a smaller value than V.

9. The method of claim 1, wherein the generative machine learning model comprises a linear embedding layer which, for the autoregressive generation process, maps a probability distribution for V values into a respective embedding of E values, where E is a different value than V.

10. The method of claim 9, wherein the generative machine learning model further comprises a transformer stack that, for the autoregressive generation process, receives the embeddings from the linear embedding layer and, in response, produces a next token feature embedding that represents a prediction for a next token of the output.

11. The method of claim 10, wherein the generative machine learning model further comprises a linear layer and a softmax function, wherein the linear layer receives the embeddings including the next token feature embedding and, in response, produces V raw output scores, and the V raw output scores are input into the softmax function which, in response, produces the first probability distribution.

12. The method of claim 1, wherein the generative machine learning model comprises a transformer stack that, for the autoregressive generation process, receives embeddings and, in response, produces a next token feature embedding that represents a prediction for a next token of the output.

13. The method of claim 1, wherein the generative machine learning model comprises a linear layer and a softmax function, and wherein for the autoregressive generation process:
the linear layer receives embeddings including a next token feature embedding and, in response, produces V raw output scores, and the V raw output scores are input into the softmax function which, in response, produces the first probability distribution.

14. The method of claim 1, further comprising training the generative machine learning model for performing the autoregressive generation process by using one or more ground truth probability distributions for supervised learning, wherein the one or more ground truth probability distributions are based on a correct golden sequence of a ground truth answer for a query.

15. The method of claim 14, wherein the one or more ground truth probability distributions are within a certain predefined margin from a one-hot encoding of the correct golden sequence.

16. A computer system comprising:
a processor set;
one or more computer-readable storage media; and
program instructions stored on the one or more computer-readable storage media to cause the processor set to perform operations comprising:
executing an autoregressive generation process of a generative machine learning model by producing a prediction of a first answer token that is represented by a first probability distribution over V values, where V represents a number greater than one of tokens in a predefined governing set of tokens,
wherein the first probability distribution is fed back as input to the generative machine learning model for a next iteration of the autoregressive generation process,
wherein the next iteration produces a next answer token represented by a next probability distribution, and
wherein the executing produces an output from the generative machine learning model, the output being based on probability distributions including the first probability distribution and the next probability distribution.

17. The computer system of claim 16, wherein the executing further comprises:
selecting a first value with a greatest probability of the V values of the first probability distribution;
selecting a next value with a greatest probability of the V values of the next probability distribution; and
translating the first value and the next value to a first output token and to a second output token, respectively, based on the predefined governing set of tokens;
wherein the output is a sequence of data that includes the first output token and the second output token.

18. The computer system of claim 17, wherein the autoregressive generation process continues with the feeding back for producing additional answer tokens until a limiting criterion is reached, and wherein the selecting of the first value, the selecting of the second value, and the translating occur in response to the limiting criterion being reached and after a last probability distribution for a last token for the output is produced in the autoregressive generation process.

19. The computer system of claim 8, wherein for each iteration of the autoregressive generation process a set of all probability distributions including the first probability distribution and the next probability distribution is fed back as the input to the generative machine learning model for the next iteration of the autoregressive generation process.

20. A computer program product comprising:
one or more computer-readable storage media; and
program instructions stored on the one or more computer-readable storage media to perform operations comprising:
executing an autoregressive generation process of a generative machine learning model by producing a prediction of a first answer token that is represented by a first probability distribution over V values, where V represents a number greater than one of tokens in a predefined governing set of tokens,
wherein the first probability distribution is fed back as input to the generative machine learning model for a next iteration of the autoregressive generation process,
wherein the next iteration produces a next answer token represented by a next probability distribution, and
wherein the executing produces an output from the generative machine learning model, the output being based on probability distributions including the first probability distribution and the next probability distribution.
